(19) United States
(12) Patent Application Publication
(10) Pub. No.: US 2008/0170710 A1
(43) Pub. Date: Jul. 17, 2008

(54) HEADPHONE DRIVER WITH IMPROVED FREQUENCY RESPONSE

(75) Inventor: Shawn Pasternak, Long Beach, CA (US)

Correspondence Address: INSKEEP INTELLECTUAL PROPERTY GROUP, INC, 2281 W. 190TH STREET, SUITE 200, TORRANCE, CA, 90504, US

(73) Assignee: Solteras, Inc.

(21) Appl. No.: 11/939,511

(22) Filed: Nov. 13, 2007

Related U.S. Application Data
(60) Provisional application No. 60/865,580, filed on Nov. 13, 2006.

(51) Int. Cl. H04R 1/10

(52) U.S. Cl. 381/74

(57) ABSTRACT

A preferred embodiment according to the present invention includes a headphone with improved frequency response. More specifically, the headphone includes a driver having an elongated port (e.g., a cylinder, tube, cube, or any shaped protrusion having a passage through it) that changes the acoustic frequency response of the driver. Thus, by adjusting characteristics such size, shape and location of the port, a designer can achieve a more desirable frequency response for the headphone.

### RELATED APPLICATIONS

This application claims priority to U.S. Provisional Application Ser. No. 60/865,580 filed Nov. 13, 2006 entitled Apparatus and Method for Tuning Headphone Drivers which is hereby incorporated by reference.

### BACKGROUND OF THE INVENTION

Headphones are well known in the art for reproducing sound in close proximity to a user's ears. For example, U.S. Pat. No. 4,239,945 and U.S. Pub. No. 2006/0188121, hereby incorporated by reference, illustrate two known headphone designs.

Generally, headphones include an outer casing or shell that contains a driver for reproducing sound. The driver typically includes a diaphragm connected to a voice coil. The voice coil creates an electromagnetic field, causing the coil to attract or repel from a nearby permanent magnet. The movement of the voice coil vibrates the diaphragm, thereby creating sounds.

Due to the small size of headphones, especially those designed to fit within the ear of the user, achieving a desired frequency response range can be difficult. For example, a headphone can be configured to have good high end frequency response but will often lack a desired low end frequency response. In another example, a headphone can be configured to have a good low end frequency response but will often lack a desired high end frequency response.

Presently, the frequency response of headphone drivers is adjusted by placing resistive material, such as fabric, within one or more holes in the back plate of the driver. Depending on the resistive material used, the location of the holes and other factors, different frequency response features can be dampened.

However, achieving a desired frequency response with this technique remains difficult. For example, driver designers must make assumptions as to how resistive material will damp frequencies. Further, the resistive material alone is not always precise enough to achieve a desired frequency response. Additionally, headphones have become increasingly small (e.g., “ear bud” headphones for placement within an ear) which dramatically decreases the ability of the headphone to reproduce an accurate or desirable frequency response.

### SUMMARY OF THE INVENTION

A preferred embodiment according to the present invention includes a headphone with improved frequency response. More specifically, the headphone includes a driver having an elongated port (e.g., a cylinder, tube, cube, or any shaped protrusion having a passage through it) that changes the acoustic frequency response of the driver. Thus, by adjusting characteristics such as size, shape and location of the port, a designer can achieve a more desirable frequency response for the headphone.

### BRIEF DESCRIPTION OF THE DRAWINGS

FIG. 1 illustrates a cross sectional view of an earphone according to a preferred embodiment of the present invention;

FIG. 2 illustrates a cross sectional view of a driver of the earphone of FIG. 1;

FIG. 3 illustrates a perspective view of the driver of FIG. 2;

FIG. 4 illustrates a cross sectional view of an earphone according to a preferred embodiment of the present invention;

FIG. 5 illustrates a cross sectional perspective view of the earphone of FIG. 4;

FIG. 6 illustrates a perspective view of a driver according to a preferred embodiment of the present invention;

FIG. 7 illustrates a perspective view of a driver according to a preferred embodiment of the present invention;

FIG. 8 illustrates a side view of the driver of FIG. 7; and,

FIG. 9 illustrates a top view of the driver of FIG. 9.

### DETAILED DESCRIPTION OF THE INVENTION

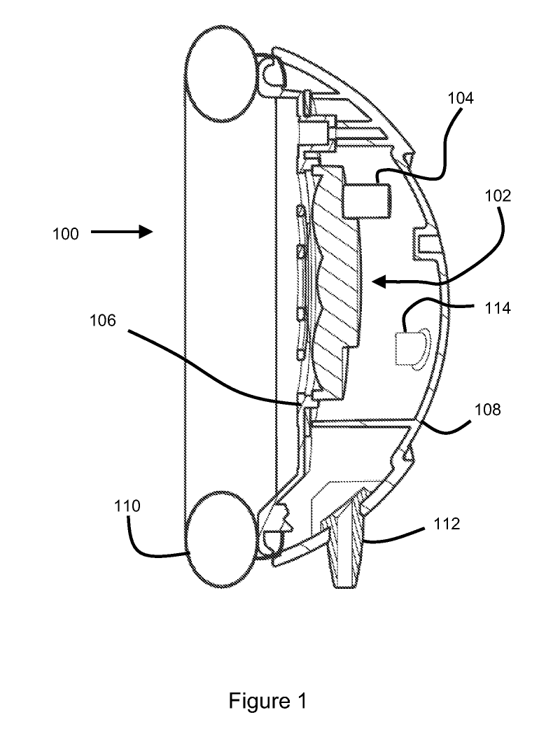

FIG. 1 illustrates a preferred embodiment of a headphone 100 with improved frequency response according to the present invention. More specifically, the headphone 100 includes a driver 102 having an elongated port 104 (e.g., a cylinder, tube, cube, or any shaped protrusion having a passage through it) that changes the acoustic frequency response of the driver 102. Specifically, the port 104 causes resistance to air flow at specific frequencies while having minimal resistance at other frequencies (acoustic impedance). Thus, by adjusting characteristics such as size, shape and location of the port 104, a designer can achieve a more desirable frequency response for the headphone 100.

As seen in FIG. 1, the headphone 100 includes an outer shell or case 108 that contains the components of the headphone 100. A plate 106 is connected to the case 108, including a plurality of apertures or other spaces which allow sound to travel outside of the headphone 100 and to the user's ear. A compliant pad 110 is located on an outer edge of the headphone 100 to comfortably rest against the user's head.

The driver 102 having the elongated port 104 is mounted or supported within the case 108. To facilitate air movement into and out of the case 108, a case port 114 is included within the case, however, it should be understood that this port 114 is optional. The bottom of the case 108 also includes a wire port 112 which allows an electrical wire connected to the driver 102 to pass through the casing 108.

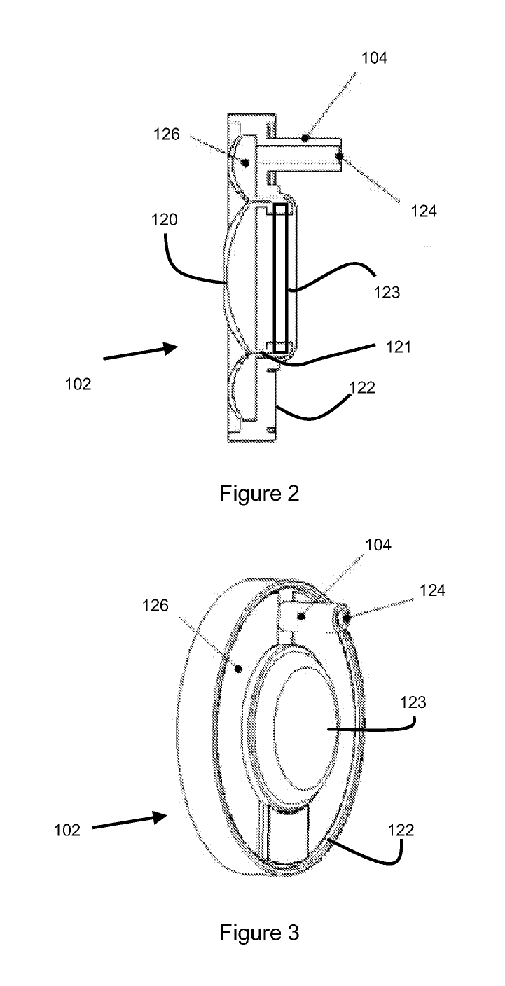

Turning to FIGS. 2 and 3, the driver 102 includes a driver body 122 that forms the framework of the driver 102. A diaphragm 120 is positioned at a center portion of the driver 102 and surrounded by a voice coil 121. A permanent magnet is positioned behind both the diaphragm 120 and the voice coil 121. The circumference of the diaphragm 120 is surrounded by an acoustically resistive damping material 126 which limits or attenuates air flow through openings in the back (i.e., opposite side as the diaphragm 120) of the driver 102, including elongated port 104 having passage 124 in communication with the damping material.

The voice coil 121 is connected to an electrical wire (not shown) which further connects to an audio device, thereby providing an electrical audio signal. This electrical audio signal increases or decreases the charge on the voice coil 121 and therefore its attraction to magnet 123. In this respect, the voice coil 121 vibrates the diaphragm 120, creating sound and displacing air.

The damping material 126 limits or controls the movement of the displaced air into or out of the headphones. A portion of this displaced air passes through the passage 124 of the elongated tube 104, changing the frequency response of the headphone 100.

Generally, the elongated tube 104 can be modified to change the characteristics of the frequency response. For example, increasing the length of the tube 104 or reducing the diameter of the passage 124 will increase acoustic impedance while decreasing the tuning frequency. In other words, the diameter of passage 124 can be enlarged to decrease the acoustic impedance, but the length of the passage 124 must be increased to maintain the same tuning frequency. If excessively large in diameter, the passage 124 will begin to loose effectiveness as the impedance decreases.

In a more specific example, the diameter of the driver 102 is 40 mm and includes a round passage diameter of 2 mm and a 9 mm length. With these dimensions, the passage 124 has a high acoustic impedance above 80 Hz (i.e., the resonant frequency) while allowing enough airflow to have a low acoustic impedance at frequencies below 80 Hz. This sizing further allows reduction of excessive level at frequencies above the tuning frequency (>80 Hz, such as 200 Hz), while allowing an increase in response below 80 Hz (bass boost). This yields a headphone that can better produce bass response.

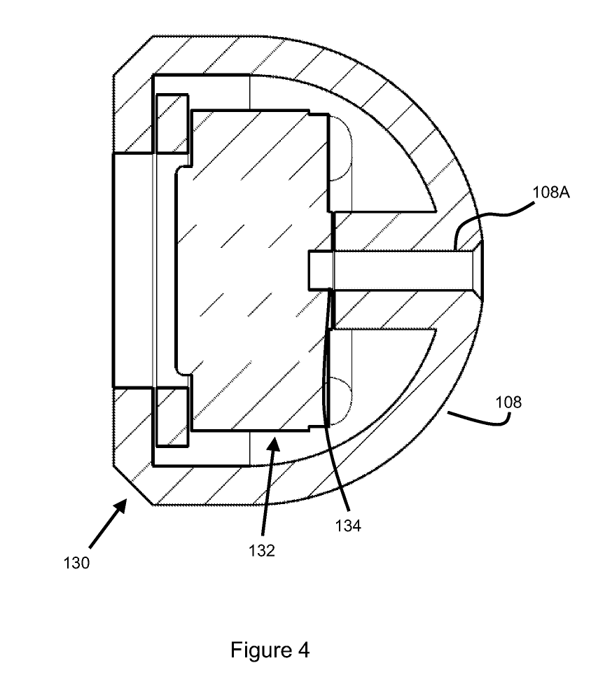

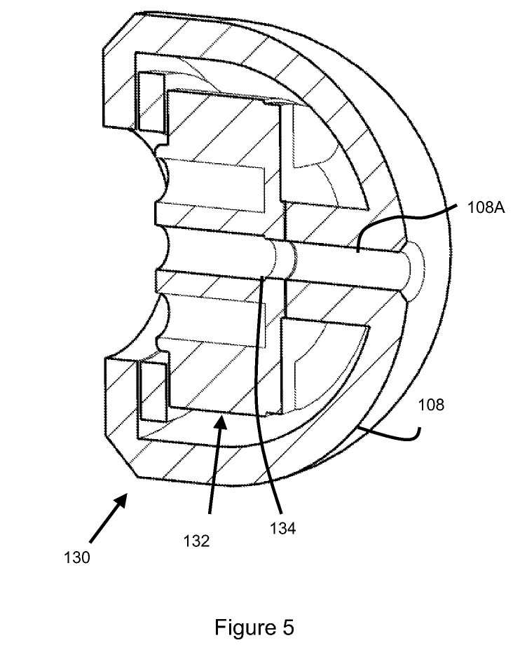

FIGS. 4 and 5 illustrate another preferred embodiment of a headphone 130 according to the present invention. The headphone 130 is generally similar to the previously described headphone 100 including a casing 108 that contains a driver 132. However, the elongated port is formed from an opening 134 in the driver 132 that mates with a casing passage 108A, thereby connecting the driver opening 134 to the open air.

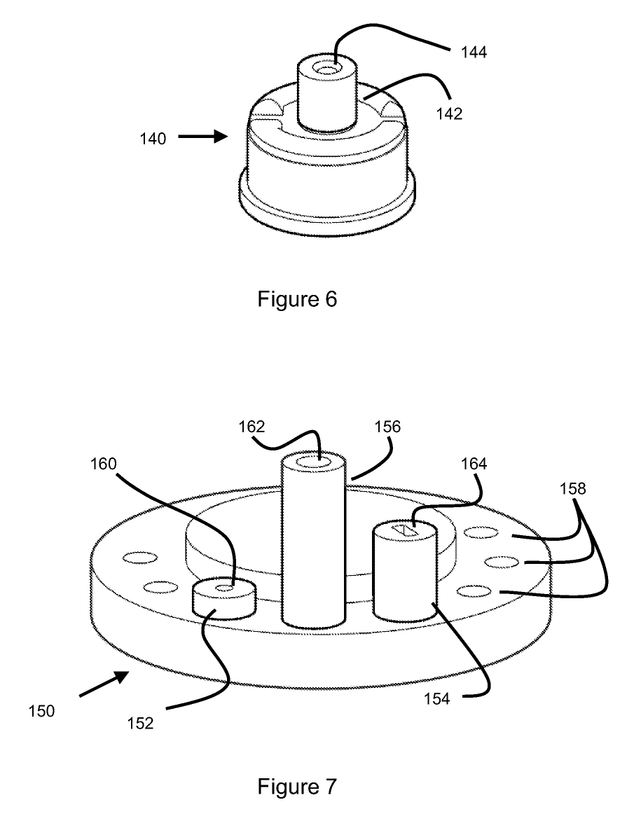

FIG. 6 illustrates another preferred embodiment of a driver 140 according to the present invention. The driver 140 is generally similar to the driver 102. However an elongated port 142 is located at a center of the driver 140, including a passage 144 in communication with the interior of the driver 140.

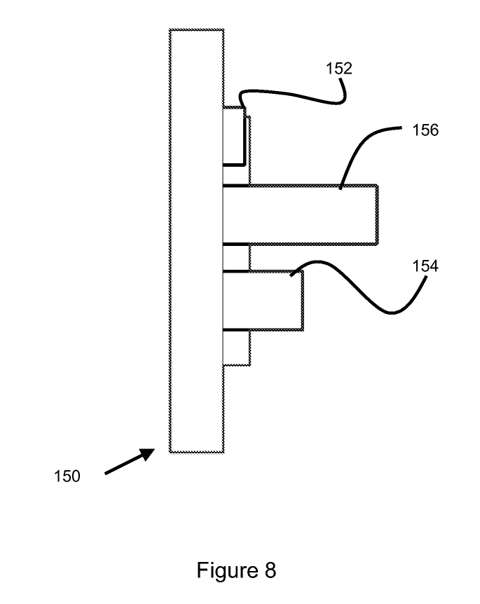

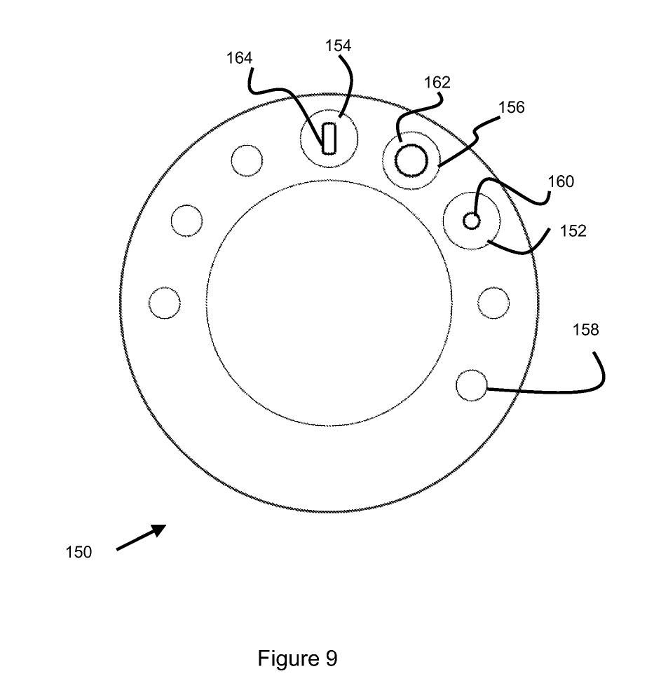

FIGS. 7-9 illustrate another preferred embodiment of a driver 150 having multiple elongated ports 152, 156 and 154 of different lengths, as well as openings 158. The shortest port 152 includes a passage 160 with a relatively small, circular diameter. The medium sized port 154 includes a rectangular passage 164. Finally, the longest port 156 includes a passage 162 with a relatively large, circular diameter. Typical tuning methods commonly used in headphones today affect a broad range of frequencies and therefore make it difficult to control specific frequency points without adjusting others. In this respect, each of the ports 152, 156 and 154 and openings 158 can be used to adjust the same frequency or different frequencies, allowing a headphone designer to more precisely adjust overall frequency response.

It should be understood that various shapes and materials of the elongated ports in the present invention can be used. However, the overall area of the passage and length of the passage of a port primarily determines the acoustic impedance and tuning frequency of the port, while secondary factors can have less of an impact. Further, any shape of the passage can be used, such as a circular, triangular, square, rectangular, hexagonal or octagonal diameter.

A designer may determine or estimate the dimensions of a port by determining a port's resonant frequency. The following chart provides example equations that may be used to determine resonant frequency and other behavioral characteristics of a port.

TABLE 1

| | Flow Velocity | | |
|---|---|---|---|
| Resonate Frequency | Profile | Resistance (R) | Inductance (L) |
| For a cylindrical porthaving a diameter(d) and a length (l): ${f}_{0} = \frac{64 n}{{πρd}^{2}}$ | f < f₀ f > f₀ | $\frac{128 n l}{{πd}^{4}}$ $\frac{128 n l}{{πd}^{4}} √ f / {f}_{0}$ | $\frac{16 ρl}{3 {πd}^{2}}$ $\frac{4 ρl}{{πd}^{2}}$ |
| For a rectangularport having a height(d), a width (b) and alength (l): ${f}_{0} = \frac{36 n}{{πρd}^{2}}$ | f < f₀ f > f₀ | $\frac{12 n l}{b {d}^{3}}$ $\frac{12 n l}{b {d}^{4}} √ f / {f}_{0}$ | $\frac{6 ρl}{5 b {d}^{2}}$ $\frac{ρl}{b {d}^{2}}$ |

Additionally, bends in the passage may be included to minimize the size of the driver and headphone. However, bends in the passage can add to the acoustic resistance. Additionally, resistive or damping materials (e.g., fabric or foam) can be placed in the passages to increase resistance through the passage and further tune the headphone.

It should also be understood that the present invention can be used with both larger “over-the-ear” headphones that are placed over the user's ears, smaller “ear buds” that are positioned in the user's ear, and any variation of headphone style.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A headphone with improved frequency response comprising:
a headphone case sized for use in connection with a user's ear;
a driver disposed in said headphone case to produce sound frequencies; said driver including a driver case;
a port member disposed on said driver case; and
a passage located within said port member; said passage having a first end open to an interior of said driver case and a second end open to an exterior of said driver case;
said passage causing acoustic impedance of sound frequencies during operation of said headphone.

2. The headphone of claim 1, wherein said driver further comprises:
a diaphragm;
a voice coil in contact with said diaphragm; and
a magnet in proximity to said voice coil.

3. The headphone of claim 1, further comprising a second port member disponsed on said driver case and a second passage located within said second port member, said second passage having a first end open to an interior of said driver case and a second end open to an exterior of said driver case.

4. The headphone of claim 1, further comprising a damping material disposed within said passage.

5. The headphone of claim 1, further comprising a second passage disposed in said headphone case; said second passage in communication with said passage and an exterior of said headphone case.

6. The headphone of claim 1, wherein a diameter of said passage includes a shape selected from a group of: circular, triangular, square, rectangular, hexagonal or octagonal shape.

7. A headphone comprising:
an outer shell shaped for contact with a human ear; and
a driver supported within said outer shell to produce sound; said driver comprising a driver case forming an elongated port having a passage therethrough; said passage extending through said outer shell;
wherein said passage is sized and shaped to selectively minimize frequencies produced by said driver while having minimal resistance on other frequencies produced by said driver.

8. The headphone of claim 7, wherein said driver case further comprises a plurality of elongated ports, each of which having a passage therethrough; said passage extending through said outer shell.

9. The headphone of claim 7, wherein said passage includes an opening within an interior of said outer shell.

10. The headphone of claim 7, wherein said passage includes an opening on an exterior of said outer shell.

11. The headphone of claim 7, wherein said passage includes a diameter having a shape selected from the following group: circular, triangular, square, rectangular, hexagonal or octagonal shape.
